(19) United States
(12) Patent Application Publication
(10) Pub. No.: US 2006/0047976 A1
(43) Pub. Date: Mar. 2, 2006

(54) Method and apparatus for generating a decrpytion content key

(75) Inventors: Paul Moroney, Olivenhain, CA (US); Alexander Medvinsky, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/159,754

(22) Filed: Jun. 23, 2005

Related U.S. Application Data
(60) Provisional application No. 60/604,324, filed on Aug. 25, 2004.

(51) Int. Cl. G06F 12/14

(52) U.S. Cl. 713/193

(57) ABSTRACT

The present invention discloses an apparatus and method for securely generating a content decryption key in an endpoint device. In one example, a nonce is acquired from a packet header from a message received at the endpoint device. The content decryption key is derived utilizing a one-way content function that uses a channel key and the nonce as input parameters.

### CROSS-REFERENCE TO RELATED APPLICATIONS

This application claims benefit of U.S. provisional patent application Ser. No. 60/604,324, filed Aug. 25, 2004, which is herein incorporated by reference.

### BACKGROUND OF THE INVENTION

1. Field of the Invention

Embodiments of the present invention generally relate to video-over-networks, e.g., video-over-IP networks. More specifically, the present invention relates to a method and apparatus for securely providing content decryption keys in a shared network.

2. Description of the Related Art

Digital content has gained wide acceptance in the public. Such content includes, but is not limited to: movies, videos, music, and the like. Consequently, many consumers and businesses employ various digital media devices or systems that enable the transmission and reception of such digital multimedia content via several different communication channels, e.g., a wireless link, such as a satellite link or a wired link such as a cable connection. Similarly, the communication channel may also be a telephony based connection, such as DSL and the like.

Regardless of the communication channels that are employed to receive the digital content, owners of digital content, as well as the service providers (e.g., a cable service provider, a telecommunication service provider, a satellite-based service provider, merchants, and the like) who provide such digital content to users, occasionally deliver content via multicast content distribution, where content decryption keys are shared among a group of endpoint devices. Unfortunately, this configuration has the potential for content piracy. For example, a subscriber's legitimate endpoint device could be disassembled leaving the cryptographic keys in the device vulnerable to extraction. To help prevent this misappropriation, keys are typically protected in a secure silicon device. However, due to high bandwidth requirements for certain content (e.g., streaming video), content decryption itself is often not implemented inside low-cost secure silicon. Therefore, even though the keys involved in key management are protected in secure silicon, the actual content decryption keys are still exposed in the host component that is responsible for decrypting the content flow. In order to deter software pirates from readily accessing the content decryption keys for reproduction and redistribution, these content keys are frequently changed. One approach adopted in several conditional access systems is to transmit the content decryption keys (in encrypted form) along with the content. However this solution consumes bandwidth and adds a layer of complexity in terms of delivery timing and reliable reception.

This same security threat of illegally re-distributing content key is also applicable to cases involving point-to-point content delivery, as long as the underlying physical network is broadcast in nature. For example, although the DOCSIS protocol allows cable modems to obtain content over point-to-point TCP/IP connections, each DOCSIS downstream is still broadcast in nature and is potentially shared between numerous users. When the content is being delivered over a point-to-point connection in this type of network, unauthorized users may still hack into the cable modem to record content that is addressed to another user over the point-to-point connection.

Thus, there is a need in the art for a more efficient method and apparatus for securely providing content decryption keys.

### SUMMARY OF THE INVENTION

In one embodiment, the present invention discloses an apparatus and method for securely generating a content decryption key in an endpoint device. Namely, a nonce is acquired from a packet header from a message received at the endpoint device. The content decryption key is subsequently derived utilizing a one-way key generation function that uses a channel key and the nonce as input parameters.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for securely generating content decryption keys in accordance with the present invention;

FIG. 2 depicts a method for securely generating content decryption keys in accordance with the present invention; and

FIG. 3 is a block diagram depicting an exemplary embodiment of a computer suitable for implementing the processes and methods described herein.

To facilitate understanding, identical reference numerals have been used, wherever possible, to designate identical elements that are common to the figures.

### DETAILED DESCRIPTION

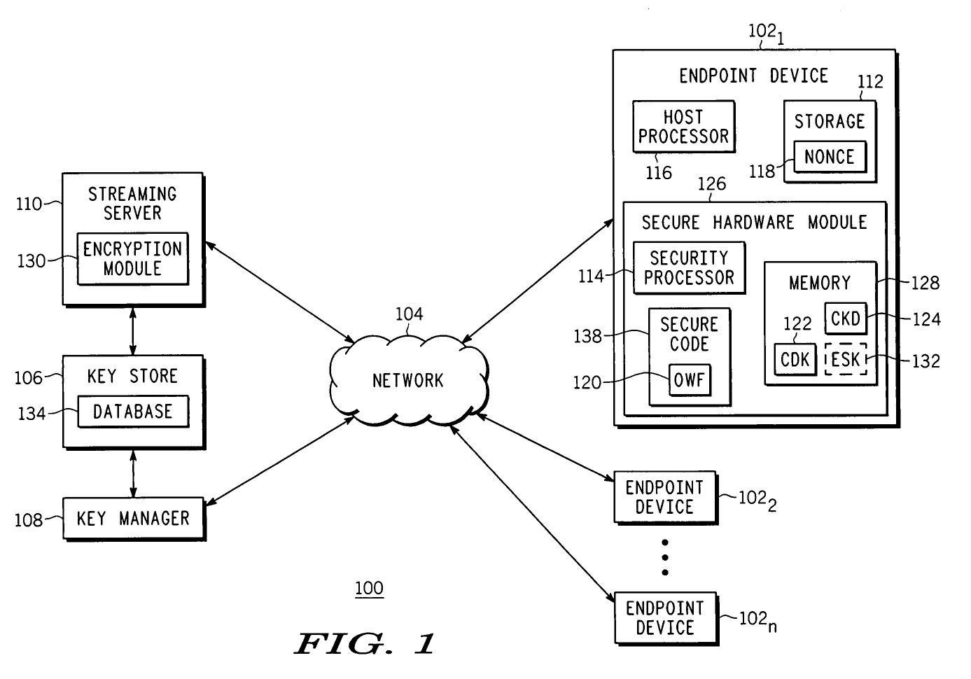

FIG. 1 illustrates a content distribution system 100 of the present invention. The content distribution system 100 may be a shared network where the content is protected using a Digital Rights Management system (e.g., an Internet Protocol Rights Management (IPRM) system) or the like. The content delivery method of this system may be point-to-point or multicast. In one embodiment, the content distribution system 100 comprises a plurality of endpoint devices 102_{1 . . . n} that are coupled to a conventional data communications network 104 (e.g., the Internet, LAN, WAN, and the like). The endpoint devices 102 may include set top boxes, cable modems, computers, cellular phones, and the like. Similarly connected to the communications network 104 are a streaming server 110 and a Key Manager 108. For the sake of simplicity, only one streaming server 110 and one Key Manager 108 are shown. Those of ordinary skill in the art understand that a plurality of streaming servers or Key Managers may be connected to the communications network 104 and to one another to form a larger system. The Key Manager 108 and streaming server 110 are also directly coupled to at least one Key Store 106.

The streaming server 110 comprises a server that is responsible for providing content to the endpoint devices 102_{1 . . . n}. In order to securely stream content between the server 110 and an endpoint device 102, the establishment of a secure session must be initiated by either the server 110 or the device 102. In order to provide content to a plurality of endpoint devices, the streaming server 110 may initiate a multicast distribution session. Multicasting is the transmission or distribution of a single object or stream of data (e.g., digital content) to a select group of recipients. During the multicast distribution of digital content, set top boxes or users do not typically initiate the streaming session, but instead join a session that is already in progress. In this scenario, the streaming server 110 generates the channel key data at the beginning of the multicast session or alternatively, sometime prior to the endpoint devices 102_{1 . . . n} joining the session. Specifically, the streaming server 110 initially generates the channel key data and then provides it to the Key Store 106 for storage. Once the Key Store 106 possesses the channel key data, it may subsequently be obtained by the Key Manager 108 (which ultimately provides the data to the endpoint devices 102_{1 . . . n}).

The streaming server 110 also contains an encryption module 130. The encryption module 130 initiates secure sessions for streaming and also for establishing channel key data with the Key Store 106. The encryption module 130 generates the nonces and the encrypted content stream that are ultimately provided to the endpoint devices 102_{1 . . . n}. In one embodiment, the encryption module 130 is the component of the streaming server 110 that produces the channel key data to be stored in the Key Store 106. In another embodiment, the streaming server 110 sends a request to the Key Store 106 for new channel key data to be created and a copy returned back to the streaming server, which passes the channel key data to the encryption module 130.

The Key Store 106 may be a stand alone server (or alternatively, it may be incorporated with another infrastructure component in the system, e.g., a streaming server) for storing channel key data. In one embodiment, communication between the encryption module 130 and the Key Manager 108 is facilitated by the Key Store 106. More specifically, the Key Store 106 is used to store channel key data that is intended for the streaming server 110 and for the Key Manager 108. In one embodiment, the Key Store 106 persistently stores channel key data in a database 134. Channel key data for each channel is generated by the Key Store 106 and returned to the streaming server 110. Alternatively, channel key data can be provided to the Key Store 106 by the streaming server 110. The channel key data stored in the Key Store 106 may be used by a Key Manager 108 as well as the streaming server 110 in the event the streaming server 110 is restarted. A channel key may be defined as a cryptographic key that is used to derive content decryption keys for a particular set of protected content streams. Since a channel key does not frequently change, it may be distributed to the endpoint devices using some form of key management rather than key derivation.

The Key Manager 108 may be a server (or alternatively, it may be incorporated with another infrastructure component of the system) that assists individual endpoint devices (e.g., set top boxes) in requesting channel key data for separate channels. In one embodiment, the Key Manager 108 requests channel key data for all existing channels from a Key Store 106 at one time. Specifically, the Key Manager 108 caches channel key data in order to minimize the number of transactions to the Key Store 106. Thus, by caching the data, the Key Manager 108 eliminates the need for obtaining the data for subsequent user requests for the same channel or content. Once provisioned with this data, the Key Manager 108 is able to distribute the key channel data to all the endpoint devices 102_{1 . . . n} upon request.

In one embodiment, the number of Key Managers in the network exceeds the number of streaming servers (and the respective encryption modules). By employing a large number of Key Managers to accommodate numerous endpoint devices 102_{2 . . . n}, the scalability concerns of the system may be addressed. Notably, there may only be a single multicast stream that is encrypted and sent out by a streaming server 110. However, there could be millions of endpoint devices tuned into a live event. A single streaming server would not be able to scale to such numbers. As a result, there is a need for a plurality of Key Managers in order to provide the requisite channel key data. Thus, this particular network configuration allows a large population of clients to be supported (i.e., as the number of endpoint devices increase, a number of Key Managers may be added in order to accommodate the potential proliferation of endpoint devices).

The endpoint devices 102_{1 . . . n} coupled to the communications network may include set top boxes, cable modems, computers, cellular phones, and the like. In one embodiment, an endpoint device 102 comprises a storage medium 112, host processor 116, and a secure hardware module 126. The channel decryption keys 122 are the keys used by the endpoint device 102 to decrypt encrypted data streams (e.g., movie data packets) and are typically found only in volatile memory (e.g., RAM) since they can always be re-created from a channel key and a nonce that is part of the content packet header.

The nonce 118 in the endpoint device is, in essence, a random number received from the streaming server 110. A nonce may also be defined as a randomly generated integer value that has effectively never been used (i.e., there is a very high probability that the value has never been used. Nonces are typically used in cryptographic communications in order to avoid using a particular message more than once. By involving a random number in a cryptographic process, it is reasonably certain the process becomes “unique” to a certain degree. In the context of this invention, a new random nonce is generated for each new content decryption key that is generated from the same channel key. In one embodiment, the nonce comprises a content key identifier (CKID) that is typically a 4-byte integer value. Due to its small size, the nonce 118 may be readily transmitted by the streaming server 110 without consuming a significant amount of bandwidth. In one embodiment, the nonce 118 is generated by an encryption module 130 and is transmitted from the streaming server 110 to an endpoint device 102 in a packet header, e.g., an IPRM message header. The urandom” nonce typically varies within the same secure session to ensure the content decryption (or authentication) keys are frequently changed. As applied to the present invention, the nonce effectively guarantees that the content decryption keys 122 are not generated in advance due to the fact that an entity (e.g., client, set top box, hacker, etc.) cannot know the random number before it is actually received at the endpoint device 102.

The host processor 116 is the component responsible for the majority of the endpoint device's functions. However, the host processor 116 is not a secure device and may be susceptible to tampering. Consequently, the host processor 116 typically only handles short lived keys, such as the final content decryption keys 122 and nonces 118 in order to deter piracy (i.e., hackers are primarily interested in longer lived components, such as the channel key data 124).

The secure hardware module 126 is the endpoint device component that contains a security processor 114, secure code 138, and a memory 128. In one embodiment, the secure hardware module 126 is composed of a secure silicon hardware device, such as a tamper resistant silicon microchip. The memory 128, which may comprise random access memory, read only memory, flash memory, cache memory, magnetic read/write memory, and the like, is responsible for securely storing the channel key data 124. The security processor 114 is a secured processor that handles the processing functions for the secure hardware module 126, such as the execution of the one-way content decryption key generation function 120. The secure code 138 is a portion of the secure hardware module 126 that comprises various software code and applications that is executed by the security processor. Notably, one secure code 138 comprises a one-way key function 120 (see below).

In one embodiment, the one-way key function 120 is a software-based function or process used to derive the content decryption keys 122 using the channel key data 124 and a nonce 118 as input parameters. Conversely, the channel key cannot be derived from the content decryption key or keys due to the “one-way” mathematical nature of this function. Notably, the content decryption key (CDK) may be mathematically described as the function: CDK=OWF(Channel Key, Nonce), where OWF is the one-way function. An example of such a one-way function would be a cryptographic hash, such as SHA-1. This invention does not rely on the secrecy of the one-way content decryption key generation function 120, however this function must still be executed inside the security processor 114 since one of the parameters to this function is the channel key data 124.

In an alternate embodiment, channel key data 124 is not stored inside the secure hardware module 126. Instead, an External Storage Key (ESK) 132 located in secure memory 128 is used by the security processor 114 to encrypt channel key data 124 and other secret information. Once the channel key data is encrypted with the ESK 132, it may be stored outside of the secure hardware module 126 in a regular storage medium 112 or the like. In the event the security processor 114 needs to perform a derivation of a content decryption key, it obtains the encrypted channel key data from the host processor 116 or directly from the outside storage 112 and then decrypts it using the ESK 132. In this embodiment, the (unencrypted) channel key data may exist only in the volatile memory of the secure hardware module 126.

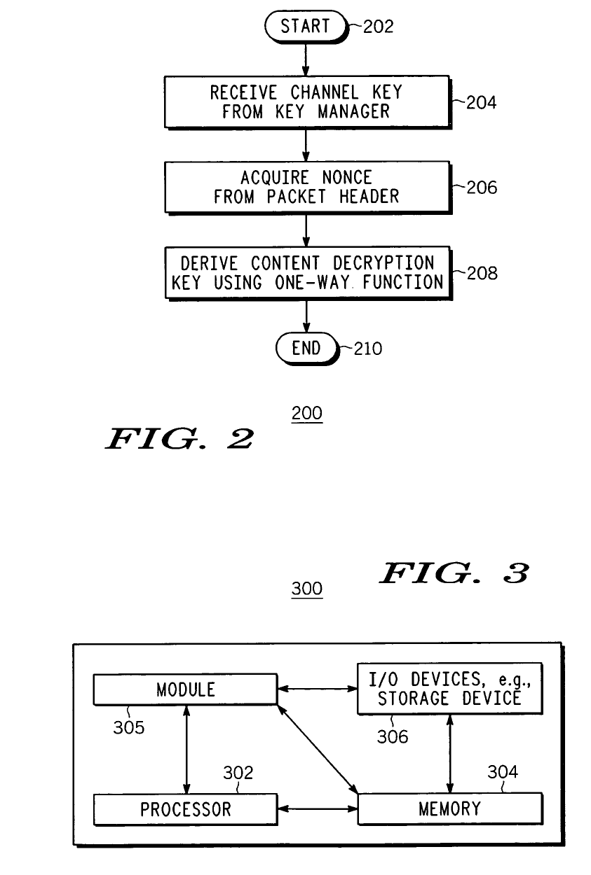

FIG. 2 illustrates a method 200 for securely deriving a content decryption key in accordance with the present invention. Method 200 begins at step 202 and proceeds to step 204 where a channel key is received from a Key Manager 108. In one embodiment of the present invention, the Key Store generates the channel key data and provides a copy of it to the Streaming server (which requested the creation of the channel key data). The Key Manager subsequently retrieves a copy of this channel key data from Key Store. The Key Manager 108 then provides the channel key data 124 to the endpoint device 102 where it is subsequently stored in a secure hardware module 126. Typically, the channel key is sent out encrypted using either the public key of the device or encrypted using another symmetric key that is already shared between the Key Manager and the device.

At step 206, a nonce is obtained from the header of a received data packet. In one embodiment, the nonce 118 is initially embedded in the packet header of a data packet that constitutes a portion of an associated encrypted content stream. More specifically, each encrypted data packet of the transmitted content stream receives an additional header after the initial encryption process. This additional header includes the random nonce value.

At step 208, a content decryption key is derived from a one-way key generation function. In one embodiment, the one-way function 120 utilizes the channel key data 124 currently residing in the memory 128 of the secure hardware module 126 and the nonce 118 as input variables. In another embodiment, the channel key data 124 is obtained in encrypted form from non-secured storage 112 and is subsequently decrypted using the ESK inside the security processor 114, before being passed into the one-way function 120 along with the nonce 118. Namely, the security processor 114 executes the one-way function 120, thus processing the appropriate channel key data 124 along with the nonce 118 to derive an associated content decryption key 122. This content decryption key 122 may then be utilized to decrypt the corresponding encrypted digital content, which was initially transmitted from the streaming server 110 along with the nonce 118. Since the key derivation process may be conducted in a relatively rapid manner, the content decryption keys 122 may be produced shortly before they are required by the encrypted digital content. This timing substantially inhibits the piracy of digital content.

Namely, a pirate “attack” cannot be conducted in advance since the hacker may only observe the content decryption keys 122 after they have been derived in the valid customer's endpoint device (inside the secure hardware module). This makes a large-scale pirate operation impractical since the distribution of a considerable amount of keying material (for a live broadcast) to unauthorized and hacked devices would have to be conducted in real time. To accomplish this, the hacker would be forced to maintain a live communication path to his pirate clients throughout the duration of the movie, thus making him more susceptible to being discovered. In addition, the unauthorized clients would now have to buffer a sufficient amount of video stream so the keys could be useful.

The method 200 continues to step 210 and ends.

In another embodiment, the content decryption keys 122 produced by the secure hardware module 126 are encrypted with a Diffie-Hellman algorithm. This safeguard protects the content decryption keys 122 as the keys are transported between the secure hardware module 126 and any host device/component in the endpoint device 102. Thus, an additional layer of security may be implemented in this fashion to make piracy attacks even more difficult.

FIG. 3 depicts a high level block diagram of a general secure purpose computer or other secure endpoint device suitable for use in performing the functions described herein. As depicted in FIG. 3, the secure system 300 comprises a processor element 302 (e.g., a CPU), a memory 304, e.g., random access memory (RAM) and/or read only memory (ROM), a content decryption key generation module 305 (i.e., the one-way function 120 in FIG. 1), and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in application specific integrated circuits (ASIC), a general purpose secure computer or any other secure hardware equivalents. In one embodiment, the content decryption key generation algorithm module or process 305 can be securely loaded into memory 304 and executed by processor 302 to implement the functions as discussed above. As such, the present content decryption key generation algorithm module 305 (including associated data structures) of the present invention would have to be stored securely on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

While the foregoing is directed to embodiments of the present invention, other and further embodiments of the invention may be devised without departing from the basic scope thereof, and the scope thereof is determined by the claims that follow.

1. A method for securely generating a content decryption key in an endpoint device, comprising:
receiving a nonce at said endpoint device; and
deriving said content decryption key from said nonce and channel key data as input parameters.

2. The method of claim 1, wherein said nonce comprises a content key identifier (CKID).

3. The method of claim 1, wherein said deriving step occurs in a security processor of said endpoint device.

4. The method of claim 1, wherein said endpoint device comprises at least one of: a set top box, a cable modem, a computer, and a cellular phone.

5. The method of claim 1, wherein said channel key data is received from a Key Manager server.

6. The method of claim 1, wherein said nonce is received from a packet header belonging to an encrypted content data stream packet received at said endpoint device, wherein said derived content decryption key is used to decrypt data in at least said encrypted content data stream packet.

7. The method of claim 1, wherein said content decryption key is derived from a one-way key generation function.

8. A system for securely generating a content decryption key in an endpoint device, comprising:
means for receiving a nonce at said endpoint device; and
means for deriving said content decryption key from said nonce and channel key data as input parameters.

9. The system of claim 8, wherein said nonce comprises a content key identifier (CKID).

10. The system of claim 8, wherein said means for deriving comprises a security processor of said endpoint device.

11. The system of claim 8, wherein said endpoint device comprises at least one of: a set top box, a cable modem, a computer, and a cellular phone.

12. The system of claim 8, further comprising:
means for obtaining said channel key data from a Key Manager server.

13. The system of claim 8, wherein said nonce is received from a packet header belonging to a content data stream packet received at said endpoint device, wherein said derived content decryption key is used to decrypt data in at least said encrypted content data stream packet.

14. The system of claim 8, wherein said content decryption key is derived from a one-way key generation function.

15. The system of claim 8, wherein a Key Store generates said channel key data and provides said channel key data to a streaming server.

16. The system of claim 8, wherein said Key Manager obtains said channel key data from a Key Store.

17. A computer readable carrier having stored thereon instruction that, when executed by a processor, causing the processor to perform a method for securely generating a content decryption key in an endpoint device, comprising:
receiving a nonce at said endpoint device; and
deriving said content decryption key from said nonce and channel key data as input parameters.

18. The computer readable carrier of claim 17, wherein said endpoint device comprises at least one of: a set top box, a cable modem, a computer, and a cellular phone.

19. The computer readable carrier of claim 17, wherein said nonce is received from a packet header belonging to a content data stream packet received at said endpoint device, wherein said derived content decryption key is used to decrypt data in at least said encrypted content data stream packet.

20. A method for securely generating a content decryption key in at least one endpoint device, comprising:
generating a nonce; and
sending said nonce to said at least one endpoint device, wherein said nonce is used in conjunction with channel key data for generating a content decryption key.
